(19) United States
(12) Patent Application Publication
(10) Pub. No.: US 2026/0084314 A1
(43) Pub. Date: Mar. 26, 2026

(54) SYSTEM AND METHOD FOR TRAINING AND USING A BIPEDAL SPATIAL PERCEPTION MODEL

(71) Applicant: Figure AI Inc., San Jose, CA (US)

(72) Inventors: Hao Wu, San Jose, CA (US); Louis Foucard, San Jose, CA (US); Christopher Stathis, San Jose, CA (US)

(21) Appl. No.: 19/342,474

(22) Filed: Sep. 26, 2025

Related U.S. Application Data
(60) Provisional application No. 63/699,201, filed on Sep. 26, 2024.
(60) Provisional application No. 63/705,802, filed on Oct. 10, 2024.
(60) Provisional application No. 63/706,778, filed on Oct. 14, 2024.
(60) Provisional application No. 63/763,209, filed on Feb. 25, 2025.
(60) Provisional application No. 63/772,440, filed on Mar. 14, 2025.

(51) Int. Cl. B25J 9/16; G06F 3/0346; G06T 7/194; G06T 7/70; G06V 10/25; G06V 10/77; G06V 10/771

(52) U.S. Cl. CPC B25J 9/1697; B25J 9/1664; G06F 3/0346; G06T 7/194; G06T 7/70; G06V 10/25; G06V 10/771; G06V 10/7715; G06V 2201/07

(57) ABSTRACT

A humanoid robot system comprises vision sensors for capturing image data, a computing architecture with processing hardware and memory, and a bipedal spatial perception model. The model includes a feature extractor that extracts hierarchical feature maps from input images, a robot data module that detects robot parts, and a robot vector data module that calculates three-dimensional spatial position and orientation data for each detected robot part. The feature extractor uses a feature pyramid network generating multi-scale feature maps through bottom-up and top-down pathways with lateral connections. The robot vector data module predicts 2D-to-3D point correspondences and solves perspective-n-point problems to obtain final position and orientation vectors, enabling real-time robot self-awareness and closed-loop visual servoing for precise object interaction.

### CROSS-REFERENCE TO RELATED APPLICATIONS

This application claims the benefit of and priority to U.S. Provisional Patent Application Nos. 63/699201, 63/705802, 63/706778, 63/763209, 63/772440, which is expressly incorporated by reference herein in its entirety.

### TECHNICAL FIELD

This disclosure relates to systems, methods, and techniques for training and using an advanced bipedal spatial perception model to detect objects, determine the objects'spatial configuration, and sense a general-purpose humanoid robot configuration relative to the detected and determined spatial configuration of said object, wherein said detection, determination, and sensing is from the perspective of said general-purpose humanoid robot.

### BACKGROUND

The field of robotics, particularly concerning general-purpose humanoid robots, has seen significant advancements. For these robots to operate effectively and autonomously or semi-autonomously, they must be able to perceive and understand their environment. A critical aspect of this environmental understanding is spatial perception, which involves detecting objects within a scene, determining their spatial configuration (e.g., position and orientation, or “pose”), and understanding the robot's own configuration relative to those objects. This capability is fundamental for a wide range of tasks, including dynamic object interaction, environmental mapping, navigation, and self-calibration.

However, conventional methods for training the perception models that enable these capabilities suffer from several significant limitations. Preexisting approaches are often computationally expensive and prone to error. A primary source of these issues is a heavy reliance on training data derived from real-world imagery that has been manually annotated by humans. This process of manual annotation is not only limited in scale but is also frequently unreliable due to operator error. The practical difficulties and expense associated with collecting and accurately labeling massive volumes of real-world data hinder the development of highly accurate and generalizable perception models.

Furthermore, traditional robotic systems often struggle with the computational demands of real-time perception and decision-making. Many systems rely on pre-programmed responses or offload processing to remote systems, which can introduce latency and lead to inappropriate actions, especially in dynamic environments. These conventional systems frequently operate with fixed computational loads, preventing efficient allocation of onboard computing resources and limiting their ability to prioritize low-latency operations critical for immediate interaction and safety. Consequently, there is a need for a more advanced and efficient system for training and deploying spatial perception models that can overcome the data-related and computational limitations of the prior art.

### SUMMARY

The presently disclosed subject matter is directed to a method for training and using a bipedal spatial perception model for a humanoid robot. Particularly, the method comprises obtaining a core dataset comprising visual image data and associated ground truth spatial configuration data for objects. The method includes generating synthetic training data by modifying configurable parameters of the core dataset using domain randomization, wherein the synthetic training data comprises a larger volume of images than the core dataset. The method includes training a bipedal spatial perception model on a training dataset comprising the core dataset and the synthetic training data, wherein the bipedal spatial perception model is configured to detect objects, determine spatial configurations of the objects, and determine spatial configurations of robot parts from two-dimensional image data. The method includes deploying the trained bipedal spatial perception model on the humanoid robot. The method includes using the deployed bipedal spatial perception model to process image data captured by the humanoid robot to generate outputs comprising object detection data, object vector data representing spatial configurations of detected objects, and robot vector data representing spatial configurations of robot parts.

The presently disclosed subject matter is directed to a humanoid robot system. Particularly, the system comprises a plurality of vision sensors configured to capture image data. The system includes a computing architecture comprising processing hardware and memory. The system includes a bipedal spatial perception model stored in the memory and executable by the processing hardware, wherein the bipedal spatial perception model comprises a feature extractor configured to extract hierarchical feature maps from input image data, an object data module configured to detect objects in the image data and generate bounding boxes around detected objects, an object vector data module configured to calculate three-dimensional spatial position data and three-dimensional orientation data for each detected object, a robot data module configured to detect robot parts in the image data, and a robot vector data module configured to calculate three-dimensional spatial position data and three-dimensional orientation data for each detected robot part.

The presently disclosed subject matter is directed to a method for generating training data for a bipedal spatial perception model. Particularly, the method comprises obtaining a core dataset comprising visual image data with ground truth spatial configuration data. The method includes generating synthetic training data by modifying configurable parameters including object types, object characteristics, robot configurations, environmental parameters, and camera parameters using domain randomization. The method includes creating a training dataset wherein the synthetic training data comprises between 80% and 99.99999% of the total training dataset. The method includes providing the training dataset for training a bipedal spatial perception model configured to perform object detection, spatial configuration determination, and robot part configuration sensing for humanoid robot applications.

The presently disclosed subject matter is directed to a bipedal spatial perception model for humanoid robots. Particularly, the model comprises a feature extractor implemented as a feature pyramid network configured to generate multi-scale feature maps from two-dimensional image data. The model includes a mask module configured to perform segmentation operations to identify regions of interest. The model includes an object detection module configured to detect foreground objects and generate bounding boxes around the objects using the multi-scale feature maps. The model includes an object pose estimation module configured to predict three-dimensional spatial positions and orientations for detected objects by analyzing pixel correspondences. The model includes a robot part detection module configured to identify robot limbs and end-effectors within the image data. The model includes a robot pose estimation module configured to determine spatial configurations of the identified robot parts relative to a camera frame.

The presently disclosed subject matter is directed to a computing system for training a bipedal spatial perception model. Particularly, the system comprises processing hardware comprising at least one of central processing units, graphics processing units, and neural network processing units. The system includes memory configured to store training data and model parameters. The system includes a data generation module configured to create synthetic training data by modifying configurable parameters of a core dataset using domain randomization techniques. The system includes a training module configured to train a bipedal spatial perception model using supervised learning techniques on the synthetic training data. The system includes a validation module configured to compare model outputs against ground truth parameters and determine model accuracy for object detection, spatial configuration determination, and robot part pose estimation tasks.

The presently disclosed subject matter is directed to a method for real-time spatial perception in humanoid robots. Particularly, the method comprises capturing image data using vision sensors mounted on a humanoid robot. The method includes processing the image data through a bipedal spatial perception model to extract hierarchical feature maps. The method includes detecting objects within the image data and generating bounding boxes around detected objects. The method includes calculating object vector data comprising three-dimensional spatial positions and orientations for each detected object. The method includes detecting robot parts within the image data. The method includes calculating robot vector data comprising three-dimensional spatial positions and orientations for each detected robot part. The method includes outputting the object vector data and robot vector data to behavioral control systems of the humanoid robot for task execution and movement coordination.

The presently disclosed subject matter is directed to a humanoid robot control system. Particularly, the system comprises a perception system comprising vision sensors and a bipedal spatial perception model configured to process visual data and generate spatial configuration data for objects and robot parts. The system includes a behavior manager configured to receive the spatial configuration data and determine robot actions based on detected object poses and robot part configurations. The system includes a movement controller configured to coordinate robot body placement and foot placement based on spatial perception outputs. The system includes a whole body controller configured to generate joint torque data for robot actuators based on spatial relationships between detected objects and robot parts determined by the bipedal spatial perception model.

The presently disclosed subject matter is directed to a computer-implemented method of operating a humanoid robot. Particularly, the method comprises receiving, from a head-mounted vision sensor of the robot, two-dimensional image frames. The method includes extracting multi-scale feature maps from each frame. The method includes detecting, from the feature maps, one or more objects and one or more robot parts. The method includes predicting, for each detected object and each detected robot part, respective 2D-to-3D point correspondences. The method includes solving a perspective-n-point problem to output six-degree-of-freedom object pose vectors in a camera frame and six-degree-of-freedom robot-part pose vectors in the same frame. The method includes providing said pose vectors to a behavior or whole-body controller that closes a visual-servo loop to execute an interaction with the object.

The presently disclosed subject matter is directed to a humanoid robot system comprising at least one camera and a compute subsystem that executes a bipedal spatial perception model (BSPM) trained on a dataset in which a core real-world image set constitutes≤1% of a total training corpus and a synthetic set constitutes≥99% of the corpus, the synthetic set being generated by domain randomization over object class, object geometry and texture, robot poses, environmental lighting, intrinsic camera parameters, occlusion rate, camera position and motion-blur/noise image effects, each synthetic image carrying precise ground truth poses, wherein the trained BSPM outputs both object pose vectors and robot-part pose vectors from single 2D frames at run time.

The presently disclosed subject matter is directed to a non-transitory computer-readable medium storing instructions that, when executed, cause one or more processors to generate a first training dataset until a predefined coverage threshold over configurable parameter permutations is satisfied, train a BSPM, evaluate the BSPM using at least Intersection-over-Union for detection and Average Distance of Model Points for pose, upon failing a target accuracy threshold, expand to a larger, second dataset and retrain, and upon satisfying the threshold, optimize and quantize the BSPM and deploy it to the humanoid robot for edge execution.

The presently disclosed subject matter is directed to a method of generating training data for a BSPM. Particularly, the method comprises seeding from a core dataset of real or CAD-based scenes with associated physical properties. The method includes invoking a distinct machine-learning model to stochastically vary configurable parameters including intrinsic camera parameters, illumination, background, occlusion, robot configuration, and 2D sensor effects. The method includes adjusting a temperature parameter to implement curriculum learning across parameter ranges. The method includes emitting per-image ground truth for six-degree-of-freedom object and robot-part poses.

The presently disclosed subject matter is directed to a bipedal spatial perception model. Particularly, the model comprises a feature extractor implemented as a feature-pyramid network that outputs hierarchical feature maps. The model includes a first head configured to perform instance or semantic segmentation and associate pixel sets to consistent object classes. The model includes an object-vector head configured to output object pose as a position vector and an orientation quaternion solved via PnP from predicted correspondences. The model includes a robot-vector head configured to detect robot parts, including occluded parts, and to output corresponding pose vectors in a camera frame.

The presently disclosed subject matter is directed to a method of self-calibrating a humanoid robot. Particularly, the method comprises executing a BSPM to estimate six-degree-of-freedom poses of multiple robot parts in the camera frame. The method includes comparing the estimated poses to expected kinematic states. The method includes updating at least one of camera extrinsics, sensor mounting parameters, and joint encoder offsets to minimize a pose discrepancy. The method includes iterating during normal operation to maintain calibration while enabling closed-loop visual servoing.

The presently disclosed subject matter is directed to an apparatus comprising one or more processors and memory storing instructions that, when executed, cause the processors to implement a BSPM configured to from a single camera image, concurrently output 2D/3D object detections, object pose vectors, and robot-part pose vectors, and to stream said outputs to a whole-body controller that computes joint torques for manipulation relative to the detected object in real time.

The present disclosure describes a comprehensive system and method for bipedal robot spatial perception, centered on a Bipedal Spatial Perception Model (BSPM). The BSPM architecture comprises a feature extractor, implemented as a Feature Pyramid Network (FPN) with bottom-up convolutional pathways and top-down pathways using lateral connections for multi-scale feature map generation, which may employ deformable convolutions and feature alignment via learned offset fields. This feeds into multiple heads, including a mask module that performs segmentation—generating binary, instance, and attention-based masks refined by a Conditional Random Field layer to reduce computational overhead—and modules for object detection, generating bounding boxes (including oriented 3D boxes). The core outputs are calculated by object-vector and robot-vector heads, gated by a lightweight attention module. The object-vector head predicts six-degree-of-freedom (6-DOF) pose data (a 3D translation and a unit-norm orientation quaternion) for objects by regressing 2D keypoints, learning 2D-to-3D correspondences, and solving the Perspective-n-Point (PnP) problem, specifically using EPnP with RANSAC. It also outputs variance-aware pose estimates, rejecting those with high uncertainty. The robot-vector head determines the spatial configuration of the robot's own parts, trained with synthetic self-occlusion exemplars, to enable physical interaction.

The system's training relies on a vast corpus of synthetic data (constituting 80% to 99.99999% of the dataset) generated via extensive domain randomization, supplemented by a small core dataset with ground truth from calibrated precision robots. This randomization strategically modifies a wide array of configurable parameters, including: object types and characteristics (shapes, material properties, deformation via finite element analysis); robot configurations; and environmental parameters like lighting (multiple sources, HDR maps), occlusion (procedurally placed), climate, and backgrounds. It also randomizes intrinsic camera parameters (focal length, optical center, skew, distortion) and 2D sensor effects (motion blur, Poisson-Gaussian noise, rolling-shutter skew, JPEG artifacts). Data generation may employ advanced techniques such as curriculum learning with temperature annealing, diffusion models conditioned on scene graphs, and physics-based rendering. The BSPM is trained using supervised learning and transfer learning with a composite loss function (e.g., Dice, IoU, keypoint L1, pose-alignment loss) whose weights can be scheduled. A validation module assesses readiness using metrics like IoU and Average Distance of model points (ADD-S) against a predetermined accuracy threshold (e.g., ≥95%). Furthermore, the system can log failure modes to automatically re-synthesize targeted training data.

The BSPM's outputs are timestamped and streamed to a broader control architecture for real-time operation. A behavior manager—comprising a model predictive control engine, a mode manager, and an autonomy selector—receives the vector data and generates high-level control instructions. These are processed by a whole body controller, which may use a quadratic-programming layer to enforce physical constraints, to transmit joint torque data to actuators, enabling closed-loop visual servoing for object manipulation and stable locomotion guided by a movement controller with body/foot planners and a SLAM-based navigation engine. The system supports automated calibration by detecting drift and triggering routines that use high-confidence poses from calibration gestures to update camera extrinsics and joint encoder offsets. To achieve high performance (e.g., ≥30 fps with≤33 ms latency on a≤15 W embedded GPU), the BSPM is optimized via structured channel pruning and post-training 8-bit quantization, and deployed as a compiled static computation graph with operator fusion. A failsafe mode can issue a hold command upon detecting pose inconsistency, ensuring safe operation.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIG. 2;

FIG. 9 is a flowchart showing the generation of training data, training, deployment, and use of a bipedal spatial perception model;

FIG. 10 is a flowchart showing the generation of training data, training, and deploying the bipedal spatial perception model;

FIG. 11A shows an example training image that includes bounding boxes that have been drawn around the identified objects;

FIG. 11B shows an example training image that includes masks that have been placed over the background to highlight identified objects;

FIG. 11C shows an example training image that includes masks that have been placed over the identified objects;

FIG. 11D shows an example training image that includes the identification of robot parts and their associated vectors;

FIG. 12 is a diagram showing data inputs and outputs of said bipedal spatial perception model;

FIG. 13 is a flowchart showing the use of the bipedal spatial perception model to detect objects within an image;

FIG. 14 is a flowchart showing the use of the bipedal spatial perception model to determine the spatial configuration of objects contained within the image;

FIG. 15 is a flowchart showing the use of the bipedal spatial perception model to determine the spatial configuration of robot parts contained within the image;

FIG. 16 is a diagram depicting an interaction of components contained within a computing architecture of the humanoid robot of FIGS. 1-3B.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one of skill in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is in all embodiments and, in some embodiments, may not be included or may be combined with other features.

### A. Introduction

As stated above, this disclosure relates to systems, methods, and techniques for training and using an advanced bipedal spatial perception model (BSPM). The BSPM is engineered to detect objects, determine the objects' spatial configuration, and sense a general-purpose humanoid robot configuration relative to the detected and determined spatial configuration of said objects, all from the robot's own perspective. Preexisting methods for collecting such detected, determined, and sensed data are often computationally expensive and prone to error, particularly due to a heavy reliance on manual annotation and the practical limitations of real-world data collection.

Described herein are systems, methods, and techniques for training and using a BSPM to identify one or more objects in a given scene observed by a robot, estimate a detailed spatial configuration of said objects, and/or determine the robot's own configuration. The BSPM is a multitask model that executes operations such as image segmentation masking, object data extraction, object vector data calculation, robot part data extraction, and/or robot vector data calculation, all using two-dimensional image data observed by the humanoid robot (e.g., image frames from vision sensors such as cameras). The output from the BSPM can thereafter be transmitted to other components of the humanoid robot, such as learning and behavioral controllers, for further operations. For instance, the learning and behavioral controllers can use the generated pose data for online self-calibration, dynamic object interaction, and environmental mapping operations.

As another example, the BSPM of the disclosed technology is trained, at least in part, and often primarily, on synthetic data obtained from simulations of three-dimensional (3D) photorealistic environments. As further described herein, the disclosed technology may simulate these environments using a wide variety of randomized or strategically chosen parameters pertaining to the objects, camera, and environment. This process allows the system to obtain a massive volume of perfectly labeled data to train a model that can predict a relatively precise object pose estimate in a reliable and robust manner. Compared to prior art approaches that often use human-annotated data, which can be unreliable due to operator error and limited in scale, the training data collection techniques of the disclosed technology result in a more accurate and generalizable object pose estimation output.

As yet another example, the training and operation of the BSPM can be conducted on a combination of onboard learning components of the humanoid robot and a cloud-based artificial intelligence system. In some embodiments, the humanoid robot may offload certain computationally intensive and lower-priority operations (e.g., based on task urgency) to the cloud-based artificial intelligence system. This architecture enables the humanoid robot 1 to more efficiently apportion its onboard computing resources to high-priority, low-latency operations, a significant improvement compared to conventional systems with fixed computational loads.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

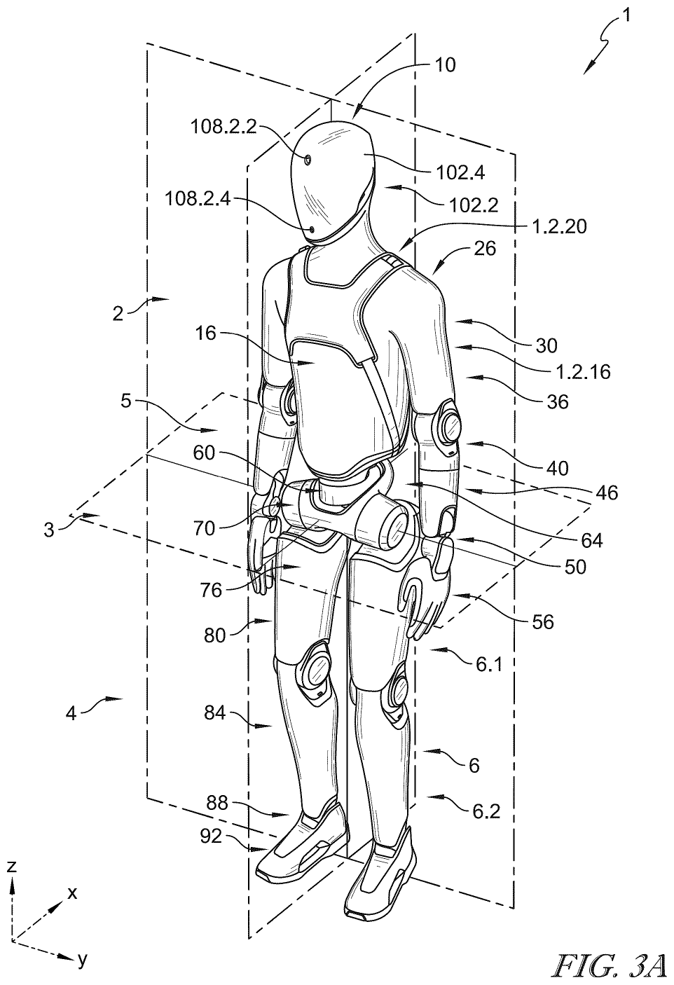

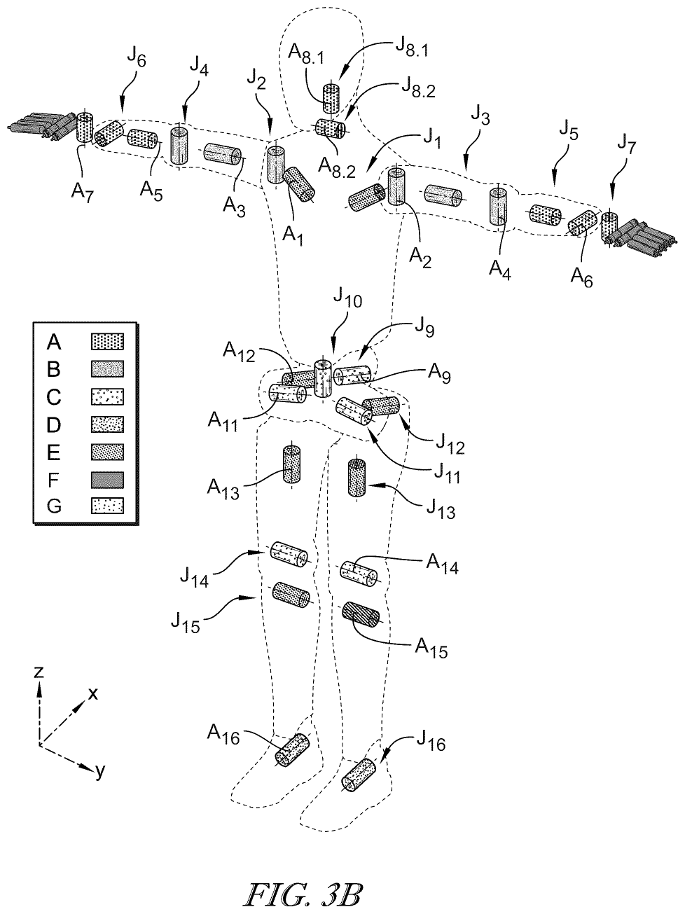

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (Ps) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (Ps) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A10 of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

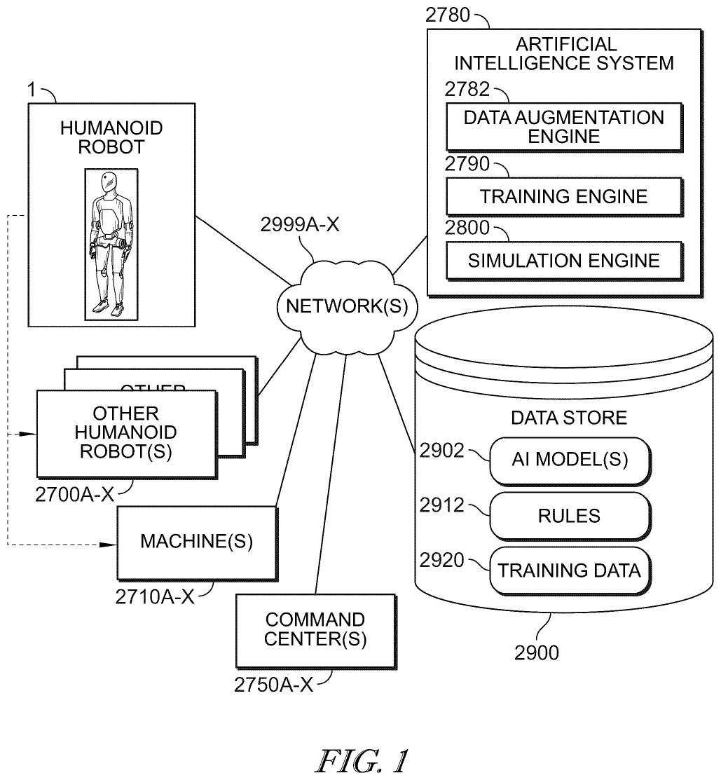

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

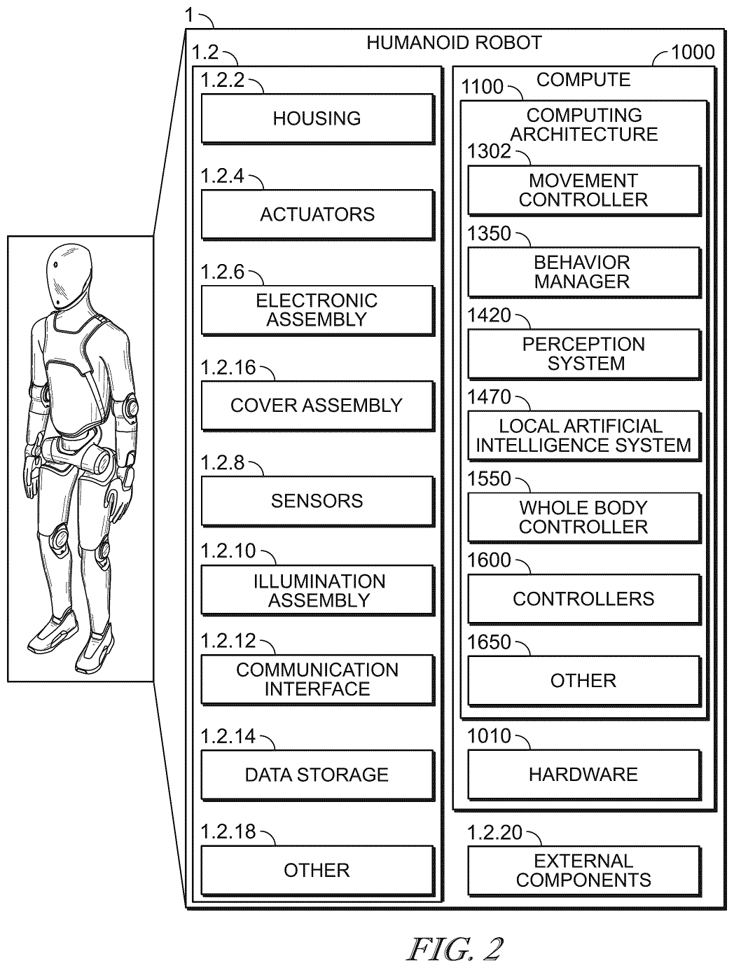

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

### A. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

### i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

### B. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

### i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

### Table 2

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

### ii. Sensors

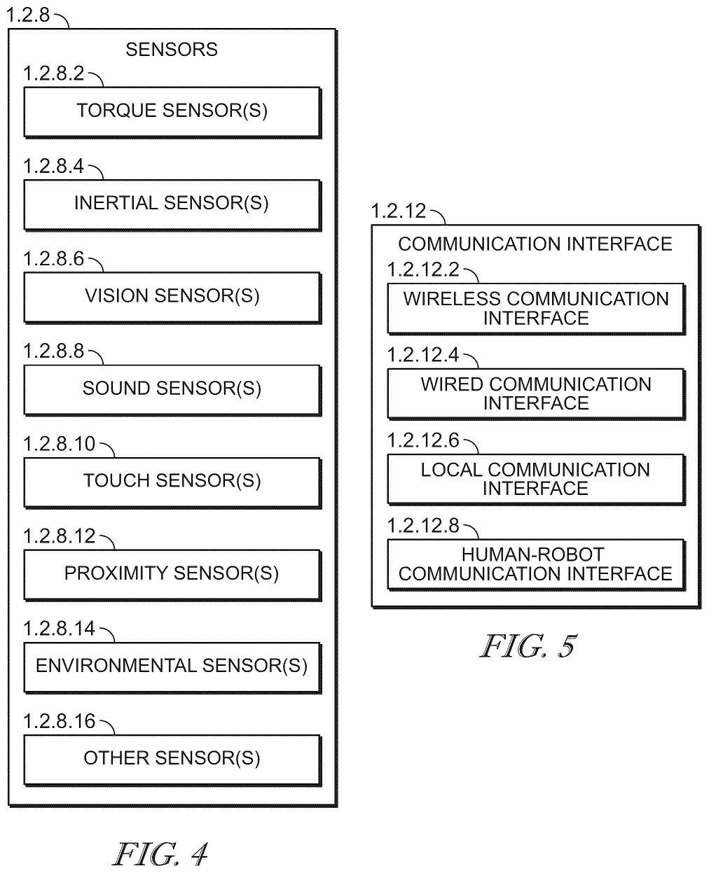

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, vision sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The vision sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Vision sensors 1.2.8.6 may also include event-based cameras, which report changes in pixel intensity rather than full frames, offering advantages in speed and data efficiency for dynamic scenes. Examples of said vision sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

### iii. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X.

Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

### C. Compute

As illustrated in FIG. 2, the compute 1000 may comprise any combination of hardware, software, and circuitry to perform the various computing functions that enable the humanoid robot 1 to operate in a semi-autonomous or fully-autonomous manner. Specifically, the compute 1000 includes: (i) compute hardware 1010, and (ii) a computing architecture 1100. The functions performed by the compute 1000 may include processing long-horizon goals, coordinating with other humanoid robots 2700A-X, processing multi-modal sensor information, controlling the humanoid robot 1 based on the sensor information and goals, controlling the activation or deactivation of mechanical components, online learning, simulating potential outcomes, refining behavioral models, and managing operational policies.

### i. Hardware

The compute hardware 1010 may operate as one or more general-purpose processors or special purpose processors (e.g., digital signal processors, application-specific integrated circuits (ASICs), field programmable gate arrays (FPGAs), etc.) that can be configured to execute computer-readable program instructions stored in the aforementioned data storage devices. Such instructions can be executed to provide various controller operations (e.g., to activate or deactivate components of the mechanical and electrical architecture, etc.). Specifically, the humanoid robot 1 may be configured with a variety of processors, such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

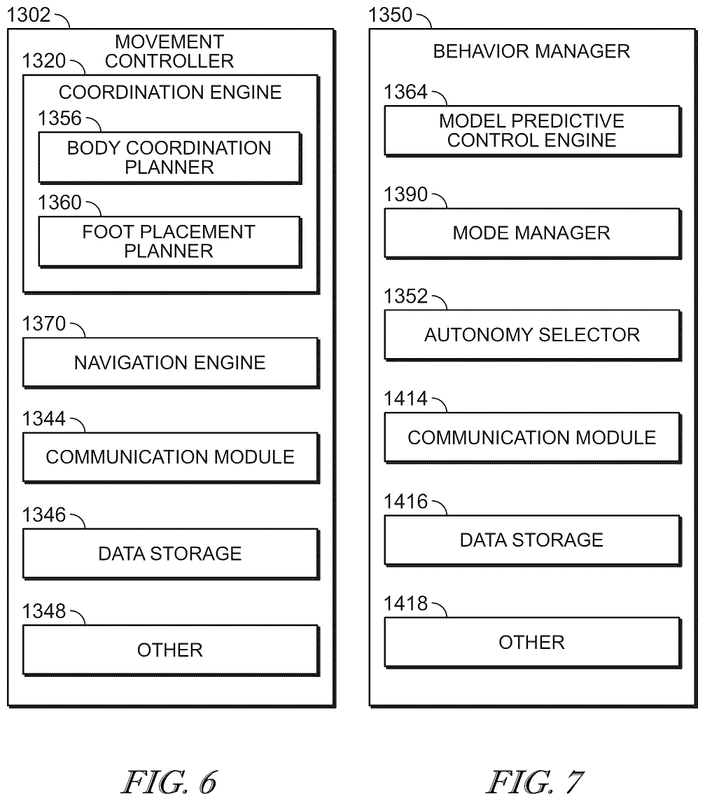

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its whole body using the body coordination planner 1356 and foot placement planner 1360 based on high-level instructions from the local AI system 1470 and/or a remote AI system 2780, (ii) navigate its world by mapping its environment (e.g., using Simultaneous Localization and Mapping, or SLAM techniques) and predict movement of objects within said environment, and (iii) communicate with its environment. The movement controller 1302 also enables the robot 1 to adapt in real-time to dynamic environments by continuously monitoring the execution of its plans and comparing expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can address the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during dynamic movements such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780 as a learned policy.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370, which may employ advanced techniques such as factor-graph-based SLAM, may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises semantic scene graphs and maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., reinforcement learning trained models) that are contained within the local AI system 1470.

### 2. Behavior Manager

Referring to FIG. 7, the behavior manager 1350 may be embodied as any hardware, software, or circuitry for managing high-level behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several technical issues in the field of robotics. One technical issue solved by the behavior manager 1350 is the integration and coordination of multiple complex modules within a single robotic system. The behavior manager 1350 also solves the technical issue of ensuring that the behaviors of the robot 1 are executed in a safe and logical order, which prevents conflicts and ensures smooth transitions between different actions or states. For example, the manager 1350 might ensure that a “stand up” behavior is completed before a “walk” behavior is initiated, or that an “object recognition” behavior, informed by the BSPM, is performed before an attempt to grasp an object is made.

The model predictive control (MPC) engine 1364 aids in predicting future states of the humanoid robot 1 and its environment based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such an MPC engine 1364 may select from or utilize different predefined routines or modes to accomplish path planning, obstacle avoidance, object grasping and manipulation, human-robot interaction, task planning and execution, coordination with other humanoid robots 2700A-X and machines 2710A-X, and safety and regulatory compliance behaviors. For safety, it may incorporate a differentiable signed-distance safety bubble to maintain margins from obstacles. Over time, the MPC engine 1364 may communicate with the local AI system 1470 to enable the MPC engine 1364 to refine its selections based on learning algorithms that identify optimal actions for the humanoid robot 1 based on the given tasks, scenarios, and constraints.

Meanwhile the mode manager 1390 can manage high-level operational modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., reinforcement learning trained models) that are contained within the local AI system 1470.

### 3. Perception System

The perception system 1420 may be embodied as any hardware, software, or circuitry for obtaining audiovisual and other sensory data (e.g., from sensors 1.2.8) and providing this data to the local AI system 1470. The local AI system 1470 is responsible for executing advanced AI-based vision and perception techniques (e.g., object detection, image classification, segmentation, object tracking, facial recognition, scene understanding, depth estimation, anomaly detection, reinforcement learning etc.) to generate, from the multi-modal data, one or more three-dimensional (3D) representations of the environment. These representations may further be annotated with rich contextual data (e.g., foreground/background information, object classification data, semantic labels, physical property vectors for mass or friction, and affordance fields) for additional processing by the local AI system 1470 and the behavior manager 1350. It should be understood that the perception system 1420 may be omitted and/or folded into the local AI system 1470.

### 4. Local Ai System

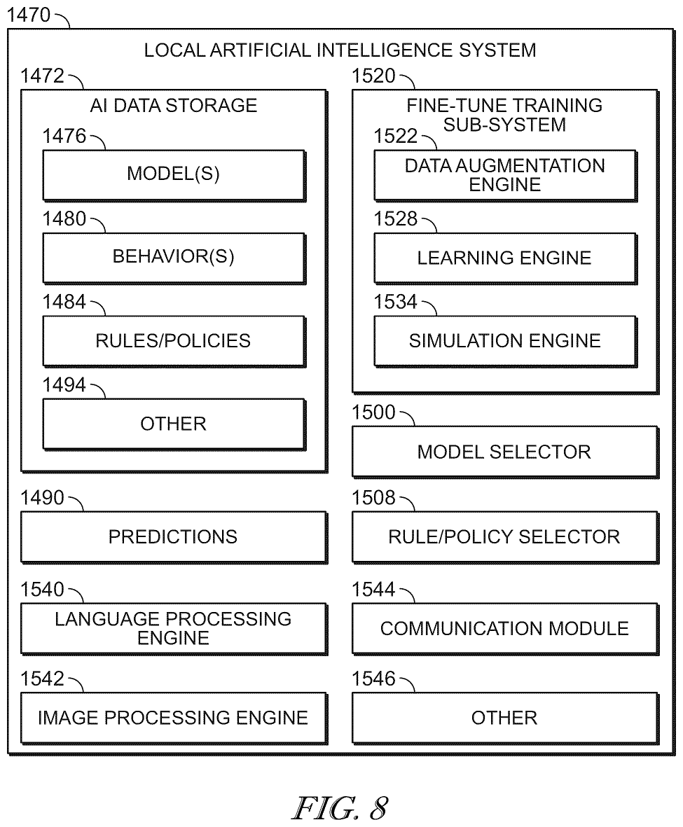

The local AI system 1470 may be embodied as any combination of hardware, software, or circuitry to drive semi-to fully-autonomous perception, learning, and behavior by the humanoid robot 1. The local AI system 1470 may: (i) include models or architectures that are run on the disclosed local AI system 1470 only, (ii) include models or architectures where a portion of the model or architecture is run on the local AI system 1470 and another portion is run on the remote AI system 2780, and (iii) include models or architectures that are run on the disclosed remote AI system 2780 only. The local AI system 1470 is described in further detail relative to FIG. 8.

Referring now to FIG. 8, the illustrative local AI system 1470 may include a variety of components, including an AI data storage 1472, a predictions module 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception system 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making at the edge. Traditional robotic systems often rely on pre-programmed responses or remote processing, which can lead to latency or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including visual, auditory, tactile, and proprioceptive systems. The local AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques such as outcome-driven self-supervision from grasp success/failure logs, to continuously refine its decision-making processes. This adaptability allows the robot 1 to improve its performance over time, learn new tasks with minimal explicit programming, and adjust to changes in its operational environment or physical capabilities using techniques like few-shot adaptation layers. A further technical challenge resolved by the local AI system 1470 is the efficient management of the limited computational resources of the robot 1. The local AI system 1470 implements sophisticated task prioritization and resource allocation algorithms, ensuring that high-priority processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech, and also to perform natural language spatial grounding to answer queries about spatial relationships in a scene. The image processing engine 1542 may be embodied as any combination of hardware, software, or circuitry for performing object detection, image classification, segmentation, object tracking, facial recognition, scene understanding, depth estimation, anomaly detection, or reinforcement learning on input visual data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. This engine may facilitate adversarial scenario synthesis, where a minimax generator creates challenging cases within safety bounds. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other components 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., reinforcement learning trained models) that are contained within the local AI system 1470.

### A. Bipedal Spatial Perception Model

The humanoid robot 1 may be configured with an artificial intelligence-based model, the Bipedal Spatial Perception Model (BSPM), to: (i) detect at least one object, and preferably a plurality of objects, from vision sensor data that is collected by said humanoid robot 1, (ii) determine the detailed spatial configuration, including the six-degree-of-freedom (6-DOF) pose, of said one or more objects that are contained in the vision sensor data, and/or (iii) determine a configuration of a part of the humanoid robot, including the pose of its own limbs and end-effectors.

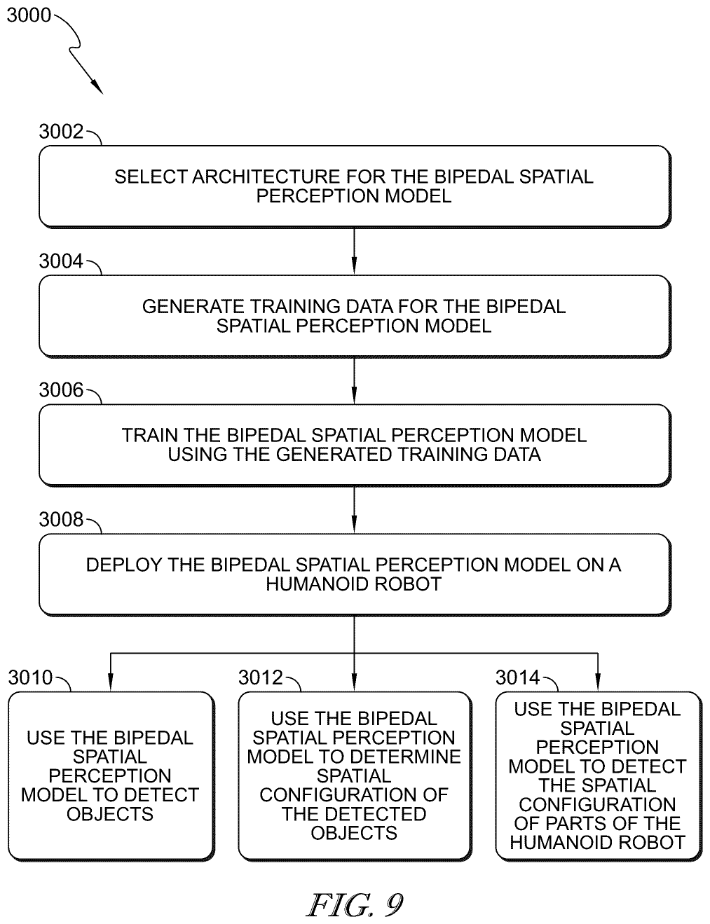

Specifically, FIG. 9 provides a flowchart depicting a method 3000 for: (i) selecting or obtaining an architecture of the bipedal spatial perception model in block 3002, (ii) generating training data for the bipedal spatial perception model in block 3004, (iii) training the bipedal spatial perception model, which may be any type of machine learning, deep learning, and/or generative AI-based model in block 3006, (iv) deploying the trained bipedal spatial perception model on a humanoid robot in block 3008, and (v) using the bipedal spatial perception model to generate outputs that include: (a) identifying objects in block 3010, (b) determining the spatial configuration of one or more objects in block 3012, and/or (c) sensing a general-purpose humanoid robot configuration relative to the detected and determined spatial configuration of said object in block 3014.

### i. Select Architecture

The first step in generating a bipedal spatial perception model is to select its architecture. Said selection may include selecting: (i) the number of model(s), (ii) the location for training the model(s), (iii) the location for running the model(s), and/or (iv) the identification of how the model(s) will interact with one another. For example, the design may select the use of a single model, that is trained in the remote AI system 2780, is designed to be run on the robot (e.g., at the edge), and the use of one model eliminates the need to determine interactions between models. However, in other embodiments, more than one model (e.g., between 2 and 10) may be used, the models may be split between the remote AI system 2780 and the local AI system 1470, and they may interact with each other using latency vectors or other communication protocols.

In addition to selecting the above factors, the designer can also select the type or technology of the model(s), the number of layers contained within each model, how many attention heads are used, the context windows, the number of parameters, the frequency that the model runs at, frequency the model runs at, and/or any other known factor or parameter. For example, the design may select any type, combination, or hybrid of any machine learning model, which includes: generative models (e.g., generative adversarial networks (GANs) (DCGAN, CycleGAN, Pix2Pix, StyleGAN, BigGAN, conditional GANs), variational autoencoders (VAEs) (conditional VAE, VQ-VAE), diffusion models (DDPM, DALL-E 2), autoregressive models (PixelRNN, PixelCNN, Gated PixelCNN), super-resolution models (SRCNN, SRGAN, ESRGAN, EDSR), image inpainting and restoration models (context encoders, partial convolutions, DeepFill)), vision transformer models (e.g., core vision transformer models (vision transformer (ViT), DeiT (data-efficient image transformers), swin transformer, PVT), or hybrid models (CaiT, CvT, conformer)), attention-based models (e.g., Self-Attention Models (SAGAN, non-local neural networks), or spatial and channel attention (SE-ResNet, CBAM, BAM)), generative models utilizing graphs and geometry (e.g., graph-based models (GCNs, geometric deep learning models), or 3D generative models (3D-GAN, PointNet++, VoxelNet)), multi-modal and cross-modal models (e.g., image captioning models (Show and Tell, Show, Attend and Tell, transformer-based image captioning), visual question answering (VQA) models (MAC Network, Pythia, ViLT), or image-text retrieval models (CLIP, ALIGN, DALL-E), self-supervised and unsupervised models, neural architecture search (NAS) models, hybrid models integrating CNNs and transformers, multi-task and multi-objective models, optimization and regularization techniques in image models (e.g., data augmentation techniques, regularization techniques, loss functions specific to image tasks), Transfer Learning and Pre-Trained Models for Images (e.g., pre-trained CNNs, pre-trained transformer models), neural radiance fields (NeRF), self-supervised learning models, meta-learning models for images, few-shot and zero-shot learning models, multi-scale and multi-resolution models, neural architecture adaptations, and/or any combination or alteration of the above models.

Further, the designer can specify that the identified model(s) include any one of or be based on the technology described in the following papers: Radford, Alec, et al. “Learning transferable visual models from natural language supervision.” International conference on machine learning. PMLR, 2021, Li, Yangguang, et al. “Supervision exists everywhere: A data efficient contrastive language-image pre-training paradigm.” arXiv preprint arXiv:2110.05208 (2021), Yao, Lewei, et al. “Filip: Fine-grained interactive language-image pre-training.” arXiv preprint arXiv:2111.07783 (2021), Rombach, Robin, et al. “High-resolution image synthesis with latent diffusion models.” Proceedings of the IEEE/CVF conference on computer vision and pattern recognition. 2022, Li, Junnan, et al. “Blip: Bootstrapping language-image pre-training for unified vision-language understanding and generation.” International conference on machine learning. PMLR, 2022, Zhang, Renrui, et al. “Llama-adapter: Efficient fine-tuning of language models with zero-init attention.” arXiv preprint arXiv:2303.16199 (2023), Liu, Haotian, et al. “Visual instruction tuning.” Advances in neural information processing systems 36 (2024), Liu, Haotian, et al. “Improved baselines with visual instruction tuning.” Proceedings of the IEEE/CVF Conference on Computer Vision and Pattern Recognition. 2024, Lin, Ji, et al. “Vila: On pre-training for visual language models.” Proceedings of the IEEE/CVF Conference on Computer Vision and Pattern Recognition. 2024, Jin, Yang, et al. “Unified Language-Vision Pretraining in LLM with Dynamic Discrete Visual Tokenization. arXiv 2024.” arXiv preprint arXiv:2309.04669, Maniparambil, Mayug, et al. “Do Vision and Language Encoders Represent the World Similarly?.” Proceedings of the IEEE/CVF Conference on Computer Vision and Pattern Recognition. 2024, Liu, Daizong, et al. “A Survey of Attacks on Large Vision-Language Models: Resources, Advances, and Future Trends.” arXiv preprint arXiv:2407.07403 (2024), Chang, Yupeng, et al. “A survey on evaluation of large language models.” ACM Transactions on Intelligent Systems and Technology 15.3 (2024): 1-45, Yin, Shukang, et al. “A survey on multimodal large language models.” arXiv preprint arXiv:2306.13549 (2023), Zhang, Duzhen, et al. “Mm-llms: Recent advances in multimodal large language models.” arXiv preprint arXiv:2401.13601 (2024), Vaswani, A. “Attention is all you need.” Advances in Neural Information Processing Systems (2017), Radford, A. “Improving language understanding by generative pre-training.” (2018), Wang, Wei, et al. “Structbert: Incorporating language structures into pre-training for deep language understanding.” arXiv preprint arXiv:1908.04577 (2019), Radford, Alec, et al. “Language models are unsupervised multitask learners.” OpenAI blog 1.8 (2019): 9, Liu, Yinhan. “Roberta: A robustly optimized bert pretraining approach.” arXiv preprint arXiv:1907.11692 (2019), Sanh, V. “DistilBERT, A Distilled Version of BERT: Smaller, Faster, Cheaper and Lighter.” arXiv preprint arXiv:1910.01108 (2019), Raffel, Colin, et al. “Exploring the limits of transfer learning with a unified text-to-text transformer.” Journal of machine learning research 21.140 (2020): 1-67, Brown, Tom B. “Language models are few-shot learners.” arXiv preprint arXiv:2005.14165 (2020), Touvron, Hugo, et al. “Llama 2: Open foundation and fine-tuned chat models.” arXiv preprint arXiv:2307.09288 (2023), Schulman, John, et al. “Proximal policy optimization algorithms.” arXiv preprint arXiv:1707.06347 (2017), Radford, Alec, et al. “Learning transferable visual models from natural language supervision.” International conference on machine learning. PMLR, 2021, Li, Yangguang, et al. “Supervision exists everywhere: A data efficient contrastive language-image pre-training paradigm.” arXiv preprint arXiv:2110.05208 (2021), Chen, Zhe, et al. “Internvl: Scaling up vision foundation models and aligning for generic visual-linguistic tasks.” Proceedings of the IEEE/CVF Conference on Computer Vision and Pattern Recognition. 2024, all of which are incorporated herein by reference and in their entirety for any purpose.

In addition to, or instead of, using any one of the above model(s), the designer may specify that the BSPM includes a feature extractor. The feature extractor is configured to detect features in the input image data such as edges, shapes, motion, and textures in the image and transmit data describing these features to other processes. In an embodiment, the feature extractor may be implemented as a feature pyramid network (FPN), which is particularly suitable for multi-scale feature extraction, such as in images where objects can appear at different sizes, scales, and orientations. As is known, an FPN is a feature extractor that generates multiple feature map layers (also known as multi-scale feature maps) in a bottom-up and top-down pathway resembling a pyramid. The bottom-up pathway uses a standard convolutional network, which may be an SE(3)-equivariant backbone to improve viewpoint robustness, to extract features at progressively decreasing spatial resolutions and increasing semantic depth. The top-down pathway then constructs high-resolution layers by upsampling the semantically rich feature maps and merging them with corresponding feature maps from the bottom-up pathway via lateral connections, ensuring that features at every scale have access to both fine-grained detail and high-level semantic information. The resulting feature maps are then output for downstream processing.

FPNs are described further in the context of image processing in the following papers: Lin, Tsung-Yi et al., “Feature Pyramid Networks for Object Detection,” arXiv:1612.03144 (2016); Kirillov, Alexander et al., “Panoptic Feature Pyramid Networks,” CVPR, 2019, Jia, Yuhang et al., “Densely Connected Feature Pyramid Networks for Image Segmentation,” IEEE (2020), Zhao, Gangming et al., “GraphFPN: Graph Feature Pyramid Network for Object Detection,” arXiv:2108.00580 (2021), Kim, Seung-Wook et al., “Parallel feature pyramid network for object detection,” Proceedings of the European Conference on Computer Vision, pp. 234-250 (2018), all of which are incorporated herein by reference and in their entirety for any purpose. Other examples of feature extractors 3304 that can be adapted to the BSPM include: (i) any one of the above models, (ii) other models that are similar to an FPN, which include variants and extensions of feature pyramid networks (e.g., PANet (path aggregation network), bi-directional feature pyramid with adaptive feature fusion (BiFPN+), NAS-FPN (neural architecture search feature pyramid network), HR-FPN (high-resolution feature pyramid network), TDM-FPN (task-driven multi-scale feature pyramid network), multi-scale feature aggregation models (e.g., spatial pyramid pooling (SPP), atrous spatial, pyramid pooling (ASPP), pyramid scene parsing network (PSPNet), deep layer aggregation (DLA), Libra R-CNN), transformer-based multi-scale models (e.g., swin transformer (Shifted Window Transformer), pyramid vision transformer (PVT), VOLO (vision outlooker), Hybrid (e.g., YOLOv5 with PANet, CenterNet, FCOS), Other (e.g., Libra R-CNN, GFPN (gaussian FPN)), and/or any combination thereof, and/or (iii) any other known machine learning model.

### ii. Generating Training Data

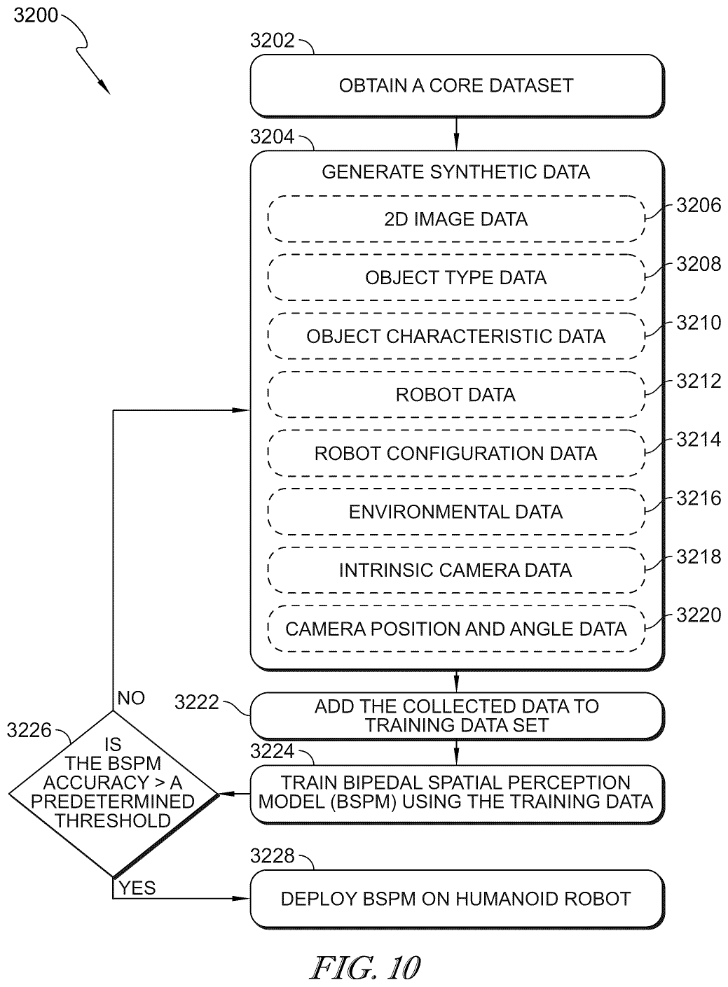

Once the architecture of the bipedal spatial perception model is selected, the designer must obtain training data to generate the bipedal spatial perception model in block 3202 of FIG. 10. Obtaining said training data starts with obtaining a core dataset in block 3202. Said core dataset may be obtained from: (i) visual image data collected from the real world, and/or (ii) visual data generated from detailed computer-aided design (CAD) objects along with their associated structural, mechanical, and physical properties. These properties may be modeled using finite element analysis (FEA) or any other type of modeling analysis to simulate how objects might deform under load, providing an additional layer of realism to the training data. If the core dataset includes visual image data collected from the real world, detailed information about the object's physical properties (e.g., size, thickness, border, length, width, etc.) and spatial position (e.g., its 6-DOF pose represented by X, Y, Z, and orientation as a quaternion or Euler angles x′, y′, z′) will be provided with the visual image as ground truth. These physical properties and the spatial position may be provided by a human annotator or, preferably, by a machine. For example, said physical properties and spatial position may be provided by a machine that moves or rotates a part in space in front of a vision sensor (e.g., camera), wherein the movement of the part is known with high precision because it is controlled by a calibrated precision robot, allowing for automatic and accurate ground truth data generation. Additionally or alternatively, the core dataset may include: (i) joint measurements for each object if it is articulated, (ii) focal length and other intrinsic measurements associated with the camera, and (iii) robot arm texture data (which can be used to ascertain distance from the robot 1 to the object).

Once the core dataset is obtained, a sufficiently large training dataset may be generated, which is primarily composed of synthetic data. Said training dataset may include: (i) the original image data from the core dataset, (ii) annotated data related to the core dataset, (iii) a large volume of images from the synthetic data, and/or (iv) the configurable parameters used to generate the synthetic data, wherein said configurable parameters have been modified using a computer program. Because the exact modification of the core dataset is known as it is based on a simulation, then perfect ground truth is known for each of the images contained in the synthetic data. Unlike the training of many other models, the training of the bipedal spatial perception model may be based primarily, or almost solely, on generated or synthetic data. For example, the data contained in the core dataset constitutes a small fraction, for example between 0.00000001% and 20%, preferably below 10%, and most preferably below 1% (e.g., between 80% and 99.99999% synthetic data), of the data contained in the overall training dataset. In other words, the core dataset is much smaller than the synthetic dataset, wherein a combination of the core dataset and the synthetic dataset form the complete training dataset. It is desirable to have the core dataset be significantly smaller than the synthetic dataset because of the difficulty and expense of accurately knowing and annotating the spatial configuration of an object in space for real-world images. While the percentage of the core dataset to the synthetic dataset may be significantly different, the designer of the training data should review at least a portion of the images contained in the synthetic dataset to ensure that visual artifacts or unrealistic hallucinations are not prevalent. Additionally or alternatively, the training dataset may omit the core dataset and may only include synthetic data. However, doing so may degrade the accuracy of the BSPM model because: (i) hallucinations in the training data may be more prevalent, and (ii) the BSPM can only be trained on data that has been generated by another model; thus, subtle randomness and other real-world factors may be omitted or missing from the dataset.

In order to generate the 3-dimensional (3D) synthetic dataset in block 3402, an alternative, secondary, or different machine learning model is used to alter or modify the configurable parameters of the core dataset in a process often referred to as domain randomization. The configurable parameters of the core dataset include, but are not limited to: (i) type of objects (e.g., sheet metal, cans, stuffed animals, plates, machines, etc.) (3206), (ii) characteristics of objects (e.g., types, shapes, sizes, material properties, textures, position, rotation, vectors, etc.) (3210), (iii) robot 1 configurations and poses (3212, 3214), (iv) environmental parameters (e.g., lighting direction and intensity, climate conditions, backgrounds, the number and position of light sources) (3216), (v) intrinsic camera parameters (e.g., focal length, skew coefficient, optical center, aperture, lens distortions) (3218), (vi) an occlusion measure (e.g., a rate by which one or more objects in the scene may be partially occluded by other objects in the scene), (vii) camera position and angles (3220), (viii) 2D image data effects like motion blur or noise (3206), (ix) any other known configurable parameter, and/or (x) any combination of the above.

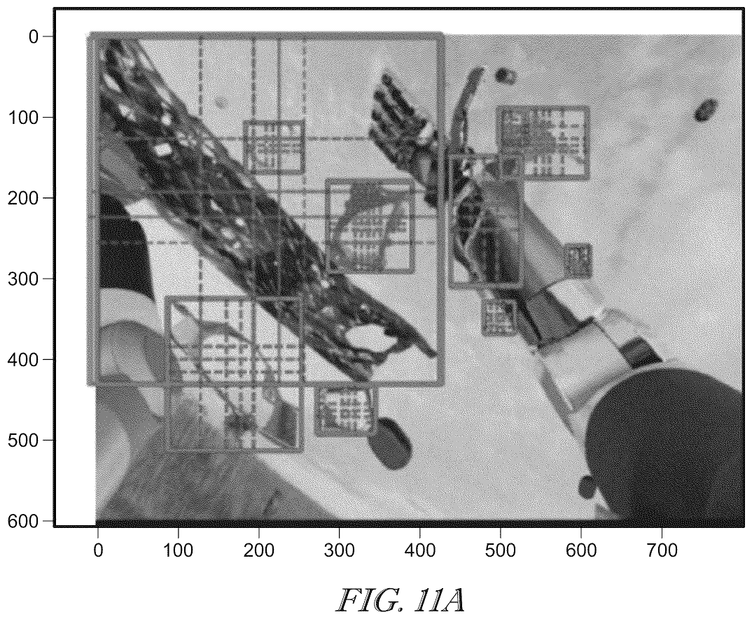

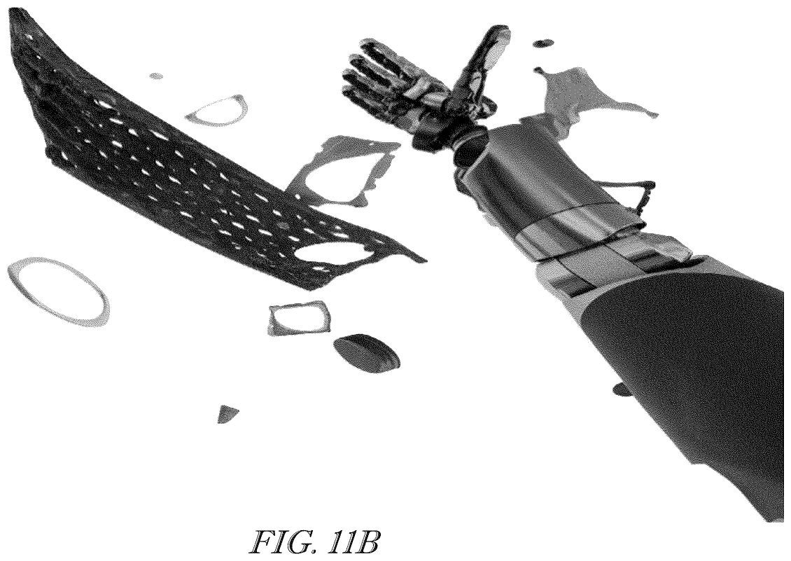

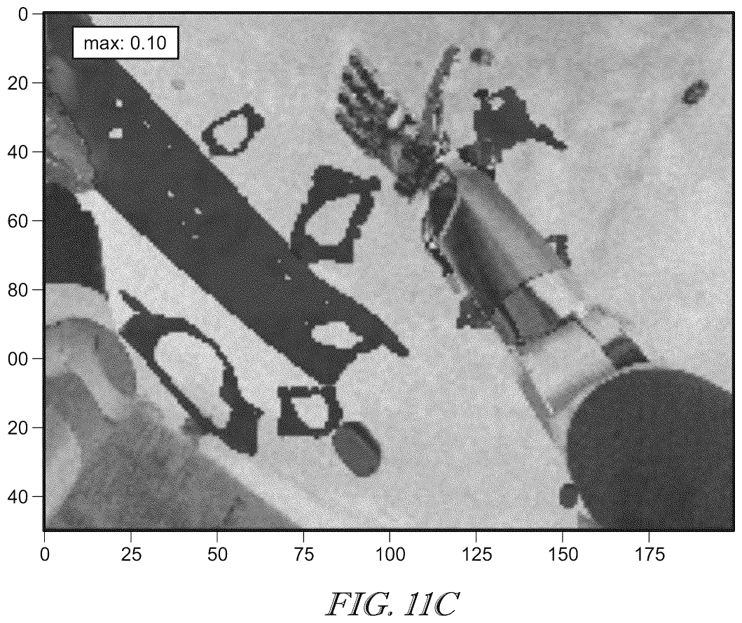

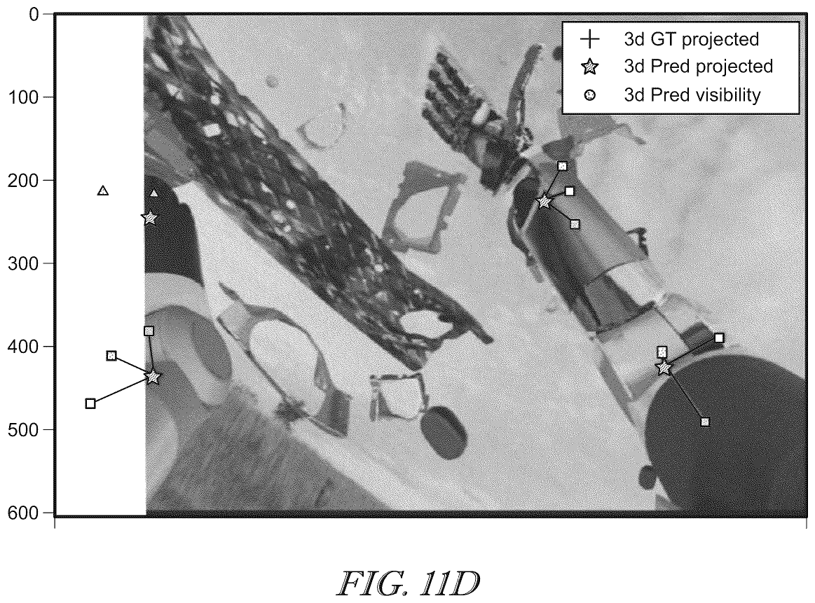

For illustrative purposes, FIGS. 11A-11D are provided as an example of the training data that may be used. FIG. 11A shows the identification of bounding boxes that are positioned around identified objects (for example, that may be output via block 3506, 3706). FIG. 11B applies a mask that hides the background to only identify the robot parts and objects in the image (for example, that would be output via block 3506). FIG. 11C applies a mask that hides the colors all of the objects a uniform color to help the identification of the robot parts (for example, that would be output via block 3706). Finally, in FIG. 11D the configuration of the robot part is identified (for example, that would be output via block 3716).

It should be understood that the changes to the configurable parameters may be completely random within specific ranges. Or, changes to the configurable parameters may be strategically chosen based on any number of specific factors, creating a form of curriculum learning. Said specific factors may include: (i) the probability of an object being located in that position based on the identified tasks that the robot will likely be performing, (ii) the type of object the robot will likely interact with, or (iii) the likelihood of a certain environmental condition or background being seen by the robot in its target operational domain. Further, the temperature or the randomness of the alternative, secondary, or different machine learning model may be varied to determine how far the configurable parameters alter or change the configurable parameters of the core dataset. Other factors, variables, or types of models (e.g., two different models may be used) may be used to generate the synthetic dataset. For instance, a closed-loop active synthetic generation process may be used, where the model requests targeted simulation batches to improve performance in specific weak regimes identified during training.

### iii. Training the BSPM

Once the training dataset has reached a first pre-determined size threshold, the bipedal spatial perception model can be trained (in block 3224) on said training dataset. Whether the training dataset has reached a first pre-determined size threshold may be determined by setting a predetermined value, wherein the predetermined value may be set by a human or by the computing architecture 1100. For example, the predetermined value may be based on: (i) a ratio of the number of permutations of configurable parameters contained in the dataset versus the total number of possible permutations, ensuring adequate coverage of the parameter space, or (ii) the number of known permutations that will likely be experienced by the BSPM in its deployment environment. Additionally, the predetermined value may be based on the available computing resources for training the BSPM. In particular, a larger dataset may be generated if there is more time and additional resources to train the BSPM. Alternatively, a smaller dataset may be generated if there is less time and/or fewer resources to train the BSPM. Finally, the predetermined value may also be simply based on the overall size of the dataset (e.g., contains 10,000 or 1,000,000 images), the storage density of the dataset (e.g., includes over 500 Gb), and/or any other value that can measure the size of a dataset.

Said training of the BSPM can be carried out on any system using the training dataset that has reached the first pre-determined size threshold, including a computing system at the command center(s), a computing node of the cloud-based AI system 2780, or the computing architecture 1100 of the humanoid robot 1. The training of the BSPM can utilize any known method of training a model, some methods that may be used include: (i) supervised learning techniques (e.g., classification, regression, etc.), (ii) unsupervised learning (e.g., clustering, dimensionality reduction, anomaly detection, etc.), (iii) transfer learning (e.g., by leveraging pre-trained models), (iv) reinforcement learning (e.g., model-free methods, model-based methods), (v) semi-supervised learning (e.g., training with labeled and unlabeled data), (vi) any other known training method, and/or (vi) any combination thereof.

Specifically, supervised learning may include training the model on the large dataset consisting of the data contained in the training dataset that was generated data. This approach allows the BSPM to adjust its internal parameters (weights and biases) to minimize a defined loss function, which measures the error between the BSPM outputs (e.g., identification of objects, objects'spatial configuration, and humanoid robot configuration) and the known ground truth provided in said training dataset. This loss function may be a composite of multiple losses, such as Dice loss for segmentation, Intersection over Union (IoU) loss for object detection, and mean squared error or L1 loss for pose vector components, thereby refining its ability to generate accurate and contextually relevant outputs. In addition to supervised learning, unsupervised learning techniques may be employed to further enhance the BSPM. These techniques primarily focus on identifying patterns and structures within the training dataset itself without explicit labels. For example, the BSPM can be trained using unsupervised methods such as clustering or self-supervised learning, where it learns to: (i) group similar objects together, (ii) identify similar visual features, and/or (iii) predict missing parts of objects or the robot. Transfer learning is another method used to fine-tune or train the BSPM. In this approach, the BSPM is first pre-trained on a large, general-purpose dataset and then fine-tuned on the smaller, domain-specific synthetic dataset. This allows the model to leverage the knowledge it has already acquired during pre-training and apply it to more specialized tasks, significantly reducing the amount of data and computational resources for training. Reinforcement learning can also be applied to fine-tune or train the BSPM, particularly in scenarios where the model needs to interact with its environment and receive feedback on its performance. In this method, the model is trained to make decisions based on inputs, with the goal of maximizing a reward signal, such as one based on successful task completion. Finally, semi-supervised learning techniques can be utilized to fine-tune or train the BSPM when a limited amount of labeled training data is available.

Next, in block 3226, the accuracy of the trained BSPM can be determined by comparing the BSPM outputs (e.g., identification of objects, objects'spatial configuration, and humanoid robot configuration) to the actual, ground truth parameters of a test dataset. Said test dataset may be contained within the training data as a hold-out set or may be a new dataset that the BSPM has never reviewed or seen before. If the accuracy of the comparison between the BSPM outputs and the ground truth parameters, as measured by relevant metrics like Intersection over Union (IoU) for detection or Average Distance of model points (ADD) for pose, is greater than a predetermined value (e.g., 90%, 95%, 97%, 99.5%), then the training of the BSPM is finalized and it is ready for deployment on the humanoid robot. This accuracy determination helps ensure that the BSPM can accurately generalize its learning to detect objects, determine the objects'spatial configuration, and sense the configuration of components of the humanoid robot for unseen objects, unseen characteristics of seen or unseen objects, unseen robot configurations, new environmental parameters, different intrinsic camera parameters, and varying camera positions or angles.

However, if the accuracy of the comparison between the BSPM outputs and the ground truth parameters is less than the predetermined value (e.g., 90%, 95%, 97%, 99.5%), further training of the BSPM may be performed. This further training may involve: (i) generating a training dataset that has a second pre-determined size threshold, wherein the second pre-determined size threshold is larger than the first pre-determined size threshold, and then further training the BSPM using any known training method, (ii) using additional training methods on the same training dataset, (iii) generating a new training dataset that includes specific target domain data to bolster specific inaccuracies of the BSPM (e.g., specific target domain data may focus on identification of sheet metal in a specific orientation, if the BSPM consistently failed to properly identify the object or its spatial configuration in that scenario), or (iv) any other known method of improving the accuracy of the BSPM. The further training of the BSPM is completed after its accuracy of the comparison between the BSPM outputs and the ground truth parameters is greater than a predetermined value (e.g., 90%, 95%, 97%, 99.5%).

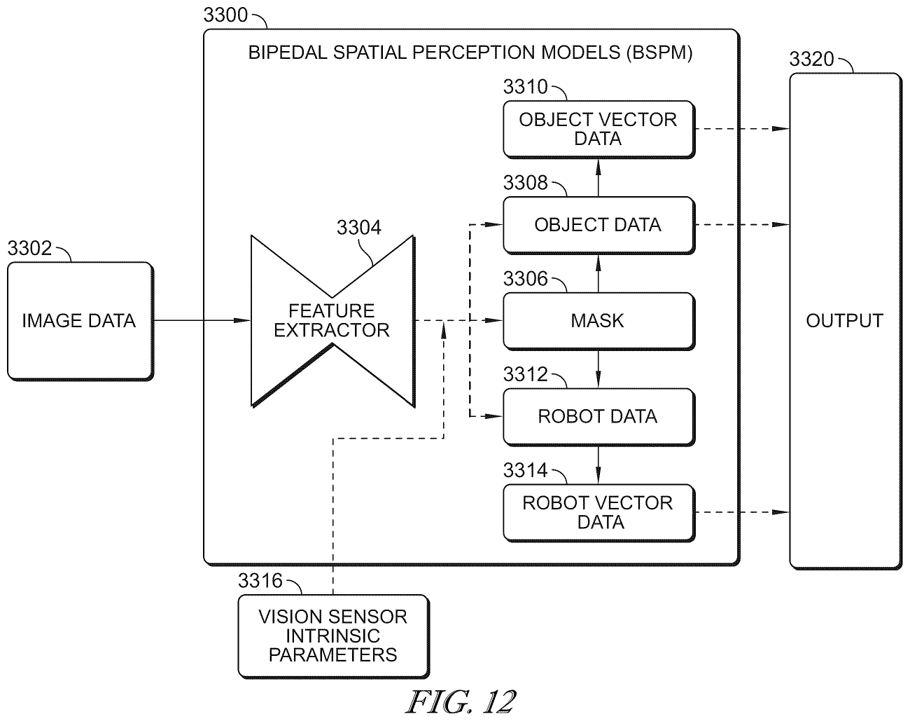

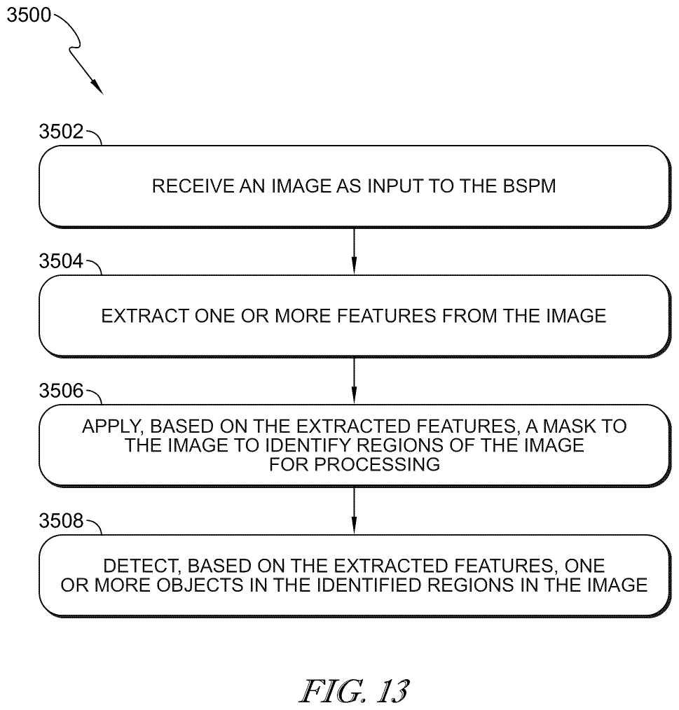

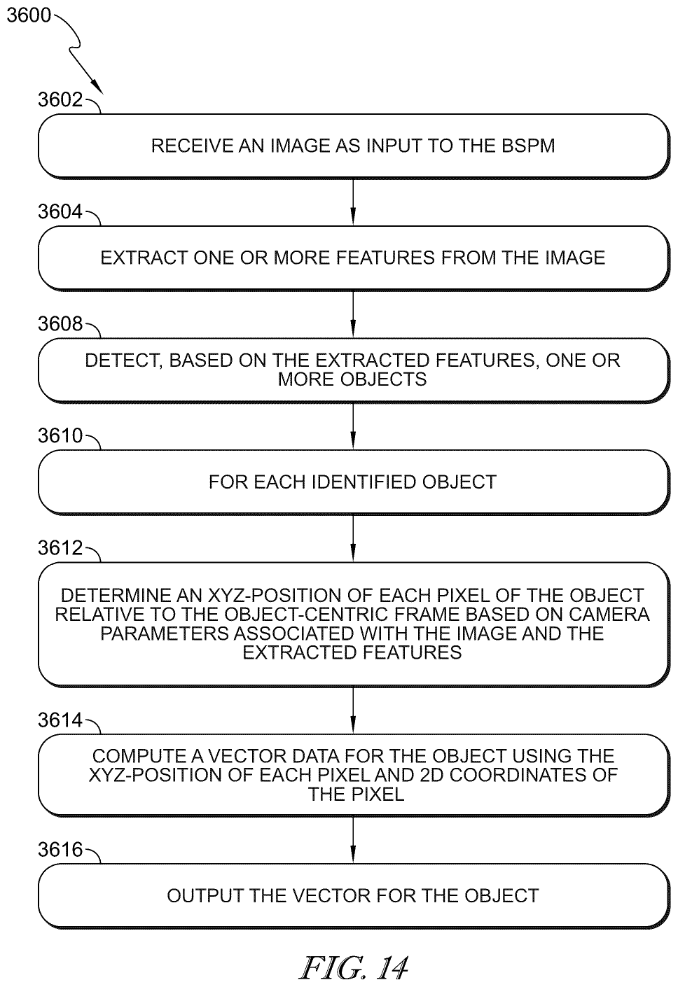

After the creation and training of the BSPM is completed, the BSPM is deployed on the humanoid robot 1 in block 3228. In the event that the model is trained externally relative to the humanoid robot 1, such as on a separate computing system or node, the trained model may be transmitted to the humanoid robot 1. For instance, the computing system may automatically push the trained model to the humanoid robot 1, or make the model available to the humanoid robot 1 for retrieval (e.g., by uploading the model to a model repository accessible by the humanoid robot 1, or storing the model on a peripheral device such as a flash drive which may be connected to the humanoid robot 1). Before deployment, the model may undergo optimization and quantization (e.g., to 8-bit integer precision) to ensure it can execute with low latency on the robot's onboard hardware. Once retrieved, the humanoid robot 1 may store the model therein. The model may be instantiated upon booting or rebooting the robot or based on a specification by a human operator or an automated command made through the model selector 1500. Referring back to FIG. 9, the humanoid robot 1 may use or execute the BSPM during the operation of said robot 1. Further details about the use or execution of the BSPM are described below and in connection with FIGS. 12-15.

### iv. Use of the Trained BSPM

FIGS. 12-15 show diagrams and flowcharts illustrating the use of the BSPM during runtime. The BSPM receives image data 3302, 3502, 3602, 3702, which can be obtained from sensors 1.2.8 (e.g., vision sensors 1.2.8.6 such as global-shutter RGB cameras installed in the head of the humanoid robot 1).

In block 3504, 3604, 3704, the computing architecture 1100, via the BSPM, uses the feature extractor 3304 to process the image data 3302, 3502, 3602, 3702 in order to extract one or more features from the image (e.g., edges, shapes, motion, and textures). More particularly, said feature extractor 3304 extracts hierarchical feature maps, in which each map represents a given characteristic such as edges, shapes, motions, and textures, at different levels of semantic abstraction. Once the feature maps are extracted, the computing architecture 1100, via the BSPM, outputs the feature maps to a mask module 3306, an object data module 3308, and/or a robot data module 3312.

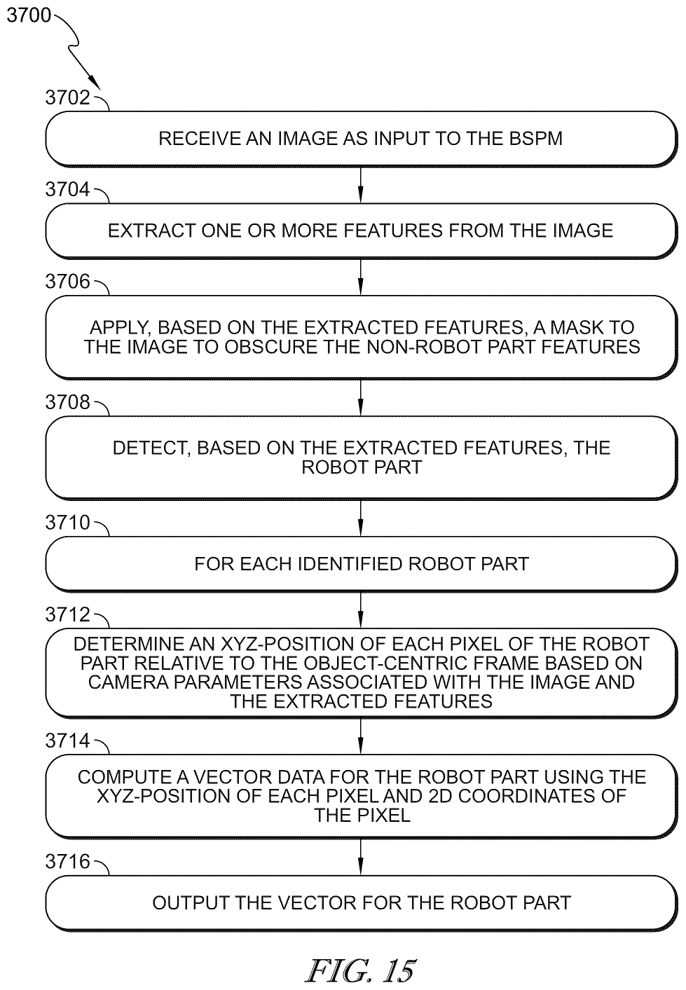

In block 3506, the computing architecture, via the BSPM, optionally uses a mask module 3306 to perform noise filtering and segmentation operations on the image data 3302 based on the extracted features. This can be done based on pattern recognition, pixel color and/or brightness (e.g., to identify object boundaries or distinguish between background portions of the image). Examples of masks that may be used by the BSPM include: binary segmentation masks, instance segmentation masks which assign a unique label to each individual object instance, semantic segmentation masks, saliency masks, attention-based masks, edge detection masks, depth-based masks, a hybrid or combination of the above, and/or any other known type of a mask. The use of the masks can result in the identification of regions of interest (e.g., regions of the image in which an object is likely located) that can be further processed, such as for the object data module 3308. This segmentation isolates objects from the background, reducing computational overhead for subsequent analysis. However, it should be understood that this step may be omitted, as shown in FIG. 15.

In block 3508, 3608, the computing architecture 1100, via the BSPM, uses the object data module 3308 to detect one or more objects. The object data module 3308 may separate foreground objects from a background and generate bounding boxes (2D or 3D) around the foreground objects, which define boundaries for each object. For example, using the multi-scale feature maps generated by the feature extractor 3304, which combine high-resolution spatial features with deep semantic features, object detection algorithms can identify objects that are smaller, occluded, or otherwise difficult to detect with high confidence.

Said object data module 3308 may also include a semantic association between the pixels contained in the 2D image and known object categories. For example, if the 2D image contains an image of a piece of sheet metal made up of 10,000 pixels that have an irregular shape and extend between the upper left region of the image and the middle of the image. Accordingly, the object data module 3308 associates these 10,000 pixels to a single object instance and assigns it the class label “sheet metal.” A similar process can also be performed by the robot data module 3312 to identify the robot's own limbs or end-effectors within the visual field. Generally, objects may pertain to any element of interest within the image, such as humans, vehicles, machines, animals, shapes, patterns, textures, and so on.

In block 3706, the computing architecture, via the BSPM, optionally uses a mask module 3306 to obscure the non-robot part features. This can be done based on pattern recognition, pixel color and/or brightness (e.g., to identify object boundaries or distinguish between background portions of the image). This segmentation helps isolate the robot parts from the background and/or other objects in the image, reducing computational overhead for subsequent analysis.

In block 3708, the computing architecture 1100, via the BSPM, uses the robot data module 3312 to detect one or more robot parts. The robot data module 3312 may separate robot parts from a background and generate bounding boxes around the robot parts, which define boundaries for each robot part. For example, using the feature maps generated by the feature extractor 3304, which combine high-resolution spatial features with deep semantic features, object detection algorithms can identify robot parts that are occluded or otherwise difficult to detect with high confidence. This process is analogous to the one performed by the object data module 3308.

In blocks 3610-3614, the objects identified by the object data module 3308 are analyzed by the object vector data module 3310 to calculate the object vector data for each object. In particular, each pixel, or set of pixels, associated with the identified object in the 2D image can be analyzed to predict its corresponding 3D spatial position data (e.g., X, Y, Z coordinates in an object-centric frame) and its 3D orientation data (e.g., represented as quaternions or Euler angles x′, y′, z′). This prediction is based upon patterns learned from the training data. For example, these predicted 2D-to-3D point correspondences may be provided as inputs for solving a perspective-n-point (PnP) problem to obtain the final position and orientation vectors for the object relative to the camera frame.

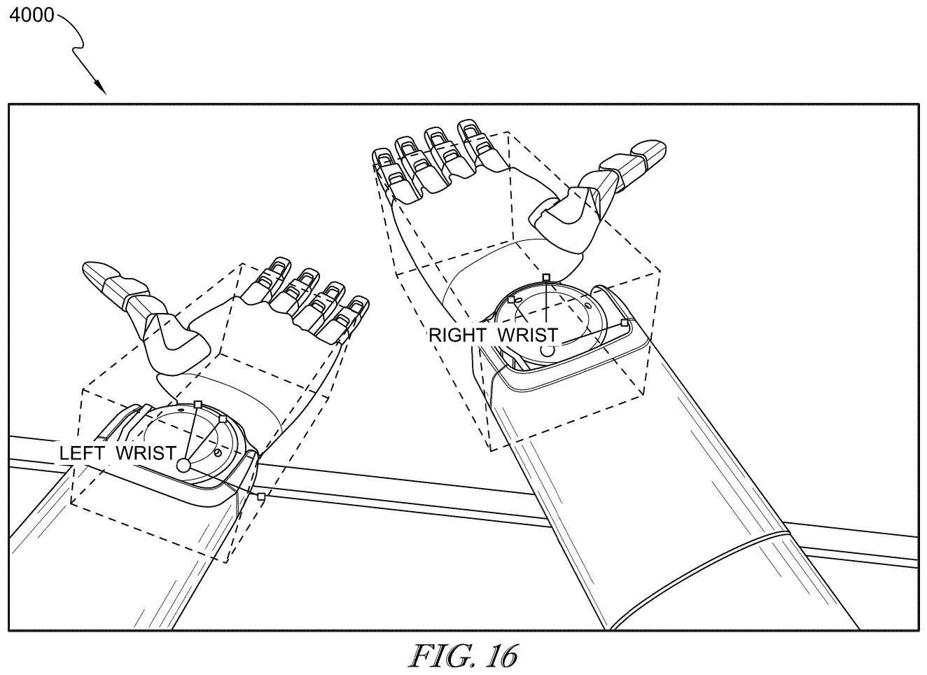

In blocks 3710-3714, the robot parts identified by the robot data module 3312 are analyzed by the robot vector data module 3314 to calculate the robot part vector data for each robot part. In particular, each pixel, or set of pixels, associated with the identified robot part in the 2D image can be analyzed to predict its 3D spatial position data (e.g., X, Y, Z coordinates in a robot-centric frame) and its 3D orientation data (e.g., represented as quaternions or Euler angles x′, y′, z′). This prediction is based upon patterns learned from the training data. For example, these predicted 2D-to-3D point correspondences may be provided as inputs for solving a perspective-n-point (PnP) problem to obtain the final position and orientation vectors for the robot part relative to the camera frame. An example of the identification of said robot vector data is graphically shown in FIG. 16.

Based on the above, the outputs 3320 of the BSPM can include: (i) object data from module 3308 (e.g., 2D/3D bounding boxes of objects identified in the image), (ii) object vector data from module 3310, which are vector representations of the objects' 6-DOF spatial configuration, (iii) robot vector data from module 3314, which are vector representations showing the spatial configuration of parts of the robot to enable said robot to have a sense of its configuration relative to the detected and determined spatial configuration of said object, and/or (iv) any other data or information, such as probabilistic pose distributions that quantify uncertainty.

In block 3616, 3716, the computing architecture 1100, via the BSPM, outputs the object vector data 3310 for the object and/or robot part vector data 3314 for the robot part. For example, the computing architecture 1100 may output the object vector data 3310 and/or the robot vector data 3314 to the behavior manager 1350 or the whole body controller 1550, which can make further determinations on, e.g., whether and how to interact with the given object based on its precise pose. Alternatively, the computing architecture 1100 may output the robot vector data 3314 to a calibration module, which can use it to perform online kinematic self-calibration of the robot 1 by comparing vision-estimated poses with proprioception. This data also enables the robot to adjust a camera sensor position, make additional measurements (e.g., a precise distance of a hand of the humanoid robot 1 to a given object), and otherwise adapt movements of the humanoid robot 1 in real-time, enabling closed-loop visual servoing when interacting with one or more of the objects within the image data 3302.

### 5. Whole Body Controller

The whole body controller 1550 may be embodied as any combination of hardware, software, or circuitry for receiving high-level control information from the behavior manager 1350 or the local AI system 1470. The whole body controller 1550 may thereafter translate these commands into low-level control signals and send the information to other components of the compute 1000. For example, the whole body controller 1550 may transmit joint torque data, which is data pertaining to rotational forces exerted at “joints” of the humanoid robot 1, to the controllers 1600. It may use advanced control strategies, such as quadratic programming, to enforce torque limits, friction cone constraints, and center-of-pressure constraints. It should be understood that the whole body controller 1550 may be omitted and/or consumed by one or more models (e.g., reinforcement learning trained models) that are contained within the local AI system 1470.

The controllers 1600 may be embodied as any combination of hardware, software, and/or circuitry for transmitting joint torque data to the actuators, e.g., to extend and retract parts such as arms, hands, and fingers of the humanoid robot 1. The controllers 1600 may also infer joint torque and angle data received from other sensors, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., reinforcement learning trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

### E. Industrial Application

The disclosed technology is directed to a specific technical solution for a technical problem rooted in computer technology. Preexisting methods for robotic spatial perception are often computationally expensive and prone to error, which severely limits a robot's ability to make real-time decisions and creates safety risks, rendering deployment in unstructured environments impractical. These methods suffer from a heavy reliance on manual data annotation and the practical limitations of real-world data collection. The presently disclosed Bipedal Spatial Perception Model (BSPM) provides a specific solution in the form of a multi-task artificial intelligence model that executes concrete operations—including image segmentation, object data extraction, object vector data calculation, and robot part vector data calculation—using two-dimensional image data captured from the humanoid robot's own vision sensors. The BSPM is not a generic computer implementation of an abstract idea, but a specific system architecture comprising distinct, interacting modules that work in concert. This includes a feature extractor that builds a rich, hierarchical foundation of visual data, upon which subsequent object and robot data modules operate to build a detailed three-dimensional understanding. The output of this system is not merely abstract data; it is immediately integrated into the robot's control loop to effect a physical, practical application. The vector data generated by the BSPM is transmitted to other components of the humanoid robot to enable tangible, real-world actions such as online self-calibration, dynamic object interaction (e.g., grasping a moving object or adjusting grip on a tool), environmental mapping, and closed-loop visual servoing, which allows the robot to make micro-adjustments to its end-effector's position based on continuous visual feedback to achieve a level of precision not possible with conventional open-loop systems.

Furthermore, a specific and unconventional method for creating the training data used by the BSPM is disclosed. This method directly addresses the noted deficiencies in prior art data collection by generating a unique training dataset. This is achieved by obtaining a small “core dataset” of real-world visual image data and then programmatically generating a significantly larger “synthetic dataset.” This synthetic data is created by systematically modifying a wide range of configurable parameters of the core data in a process called “domain randomization,” which includes varying object textures, lighting conditions, camera angles, and levels of occlusion. The final training dataset is a new and useful technical artifact-a specific data structure whose value lies not just in its massive scale, but in its perfect ground-truth labeling and engineered diversity. Composed primarily of this synthetic data (e.g., between 80% and 99.99999%), this artifact solves the technical problem of acquiring sufficient, accurately labeled data for training a robust perception model. This specific, multi-step technical process for generating a purpose-built dataset with unconventional characteristics is unlike generic data collection. Instead of simply gathering and labeling existing images, it is a constructive method wherein concrete steps are performed to transform data into a different state and a new, useful thing for the specific, practical purpose of improving the underlying technology.

The disclosed system integrates the output of its AI model to cause a specific, technological action that improves the system's function. By using robot vector data for real-time movement adaptation and self-calibration, the system enables a new capability for the robot—the ability to dynamically and precisely interact with its environment, which is a core technical challenge in robotics. This is factually analogous to other systems deemed patent-eligible that use an AI model's output to perform specific, real-time functions that result in a technical improvement. The system for training the model is likewise analogous to eligible systems that perform a series of specific steps to create a new and useful technical artifact. The creation of this dataset is not a mere pre-solution activity but is integral to the invention's success, as it is the specific nature of this generated artifact that enables the technical improvement of the final perception model. There is a direct chain of technical causality: the specific data generation method causes the creation of a superior AI model, which in turn causes an improvement in the robot's physical functioning. By performing this specific, unconventional process for generating training data, the disclosed system creates a novel training dataset that constitutes an improvement over prior data collection methods and is inextricably linked to the overall technological advancement.

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one of skill in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, Ser. No. 18/919,274, Ser. No. 18/922,334, Ser. No. 19/000,626, Ser. No. 19/006,191, Ser. No. 19/033,973, Ser. No. 19/038,657, Ser. No. 19/064,596, Ser. No. 19/066,122, Ser. No. 19/180,106, Ser. No. 19/223,945, Ser. No. 19/224,109, Ser. No. 19/224,252, Ser. No. 19/249,517, Ser. No. 19/252,392, Ser. No. 19/306,591, Ser. No. 19/319,712, Ser. No. 19/324,392, Ser. No. 19/323,751, Ser. No. 19/325,486, Ser. No. 19/325,415, Ser. No. 19/324,342, Ser. No. 19/329,008, Ser. No. 19/329,474, Ser. No. 19/329,485, Ser. No. 19/329,559, Ser. No. 19/337,845, Ser. No. 19/337,852, Ser. No. 19/337,899, and Ser. No. 19/342,470; and (iii) U.S. Design Patent Application Nos. Ser. No. 29/889,764, Ser. No. 29/928,748, Ser. No. 29/935,680, Ser. No. 29/954,572, Ser. No. 29/967,462, Ser. No. 29/993,115, Ser. No. 29/998,761, Ser. No. 30/024,341, and Ser. No. 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot system, comprising:
a plurality of vision sensors configured to capture image data;
a computing architecture comprising processing hardware and memory; and
a bipedal spatial perception model stored in the memory and executable by the processing hardware, wherein the bipedal spatial perception model has been primarily trained on a synthetic dataset and comprises:
a robot data module configured to detect robot parts in the image data; and
a robot vector data module configured to calculate three-dimensional spatial position data and three-dimensional orientation data for each detected robot part.

2. The humanoid robot system of claim 1, wherein the bipedal spatial perception model further comprises a feature extractor with a feature pyramid network that generates multi-scale feature maps through a bottom-up pathway using convolutional networks and a top-down pathway that upsamples semantically rich feature maps and merges them with corresponding feature maps via lateral connections.

3. The humanoid robot system of claim 1, wherein the bipedal spatial perception model further comprises a mask module configured to perform segmentation operations on the image data based on the extracted hierarchical feature maps.

4. The humanoid robot system of claim 1, wherein the bipedal spatial perception model further comprises:
an object data module configured to detect one or more objects in the image data; and
an object vector data module configured to calculate six-degree-of-freedom (6-DOF) pose data for each detected object.

5. The humanoid robot system of claim 4, wherein the computing architecture further comprises a behavior manager configured to receive the object vector data and robot vector data from the bipedal spatial perception model and generate control instructions for robot interaction with detected objects adaptation.

6. (canceled)

7. The humanoid robot system of claim 1, wherein the computing architecture further comprises a calibration module configured to receive the robot vector data to perform online kinematic self-calibration.

8-20 canceled

21. The humanoid robot system of claim 1, wherein the synthetic dataset is generated by, or annotated using, a separate and distinct transformer-based model.

22. The humanoid robot system of claim 1, wherein the synthetic dataset is further supplemented with specific target domain data to bolster specific inaccuracies of the bipedal spatial perception model.

23. The humanoid robot system of claim 1, wherein training of the bipedal spatial perception model includes comparing parameters generated by the bipedal spatial perception model against ground truth parameters to determine whether the bipedal spatial perception model's accuracy exceeds a predefined threshold.

24. The humanoid robot system of claim 1, wherein the bipedal spatial perception model may be used to control movements of the humanoid robot.
